(19) United States
(12) Patent Application Publication
(10) Pub. No.: US 2002/0156921 A1
(43) Pub. Date: Oct. 24, 2002

(54) Automatic backup of wireless mobile device data onto gateway server while device is idle

(75) Inventors: Rabindranath Dutta, Austin, TX (US); Richard Scott Schwerdtfeger, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/838,368

(22) Filed: Apr. 19, 2001

(51) Int. Cl. G06F 15/16

(52) U.S. Cl. 709/246; 709/219

(57) ABSTRACT

A method, system, and computer program product for backing up data from a wireless device onto a server via a network is provided. In one embodiment, a backup server, responsive to a determination that data from a wireless device should be backed up, initiates a backup process. The backup process may be initiating, for example, by pushing a request to the wireless client via a proxy/gateway server requesting that the client transmit data to be backed up to the backup server. A determination as to when to backup may be made, for example, in response to an indication that the wireless device has been powered on or in response to a determination that a predetermined amount of time has elapsed since the last backup was performed. The backup server then receives the data from the wireless device and stores the data on a storage device connected to the network for later retrieval such that if the wireless device loses its data, the data can be retrieved from the backup server and reloaded onto the wireless device. The backed up data may be, for example, phone lists, calendars, address lists, or notes.

### BACKGROUND OF THE INVENTION

1. Technical Field

The present invention relates generally to computer software and, more particularly, to providing data backup for battery operated wireless devices over a network.

2. Description of Related Art

The use of computers has become more and more pervasive in society. This pervasiveness includes the integration of personal computer technology into phones. By utilizing computer technology, users or callers have access to computing functions and resources in a personal, portable device. In addition, it is envisioned that phone users would be able to use some of the same software elements in a phone that are used at home or in the office. Various applications have been developed and are being developed for use in phones. These applications generally include communication applications to help a user stay in touch with other persons at home or in the office, such as voice mail, e-mail, or two-way paging with short text messages. Some phones incorporate so-called personal information manager (PIM) technology, such as an address book, phone lists, or a calendar for scheduling personal events.

Another adopted computer technology for use on a phone is voice and speech recognition. Voice recognition technology is already well developed in multimedia desktop personal computers and, when incorporated into a phone, allows a phone user to easily control and interact with a telephone application, such as automatically dialing a phone number, while obviating the need for manual input. Phones are becoming so ubiquitous that many people carry their phones so that they have some means for being in constant communication contact with others. Examples of common use of portable phones include carrying and using a phone within an automobile or possibly carrying the phone while shopping in a mall.

However, wireless phones as well as other wireless devices, such as personal digital assistants, are battery operated devices. Thus, the information stored on the devices are available only so long as the battery does not fail or become completely discharged. This presents the potential that data that may be very valuable to the user may be lost without any mechanism for recovery. Therefore, it would be advantageous to have a mechanism to automatically backup data from wireless devices onto a more stable platform such that the data may be retrieved if lost from the wireless device.

### SUMMARY OF THE INVENTION

The present invention provides a method, system, and computer program product for backing up data from a wireless device onto a server via a network. In one embodiment, a backup server, responsive to a determination that data from a wireless device should be backed up, initiates a backup process. The backup process may be initiated, for example, by pushing a request to the wireless client via a proxy/gateway server requesting that the client transmit data to be backed up to the backup server. A determination as to when to backup may be made, for example, in response to an indication that the wireless device has been powered on or in response to a determination that a predetermined amount of time has elapsed since the last backup was performed. The backup server then receives the data from the wireless device and stores the data on a storage device connected to the network for later retrieval such that if the wireless device loses its data, the data can be retrieved from the backup server and reloaded onto the wireless device. The backed up data may be, for example, phone lists, calendars, address lists, or notes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system diagram illustrating a plurality of interconnected heterogeneous networks in which the present invention may be implemented;

FIG. 2 depicts a block diagram of a data processing system that may be implemented as a server in accordance with a preferred embodiment of the present invention;

FIG. 3 depicts a diagram of a client in the form of a wireless telephone in accordance with a preferred embodiment of the present invention;

FIG. 4 depicts a block diagram of a wireless telephone in accordance with a preferred embodiment of the present invention;

FIG. 5 depicts a diagram illustrating data flow between the data backup server and the wireless device in accordance with the present invention;

FIG. 6 depicts a pictorial diagram illustrating data flow for a client retrieving backed up data in accordance with the present invention;

FIG. 7 depicts a process flow and program function for backing up data from a wireless device onto a server in accordance with the present invention; and

FIG. 8 depicts a process flow and program function for reloading backed up data onto a client in accordance with the present invention.

### DETAILED DESCRIPTION OF THE PREFERRED EMBODIMENT

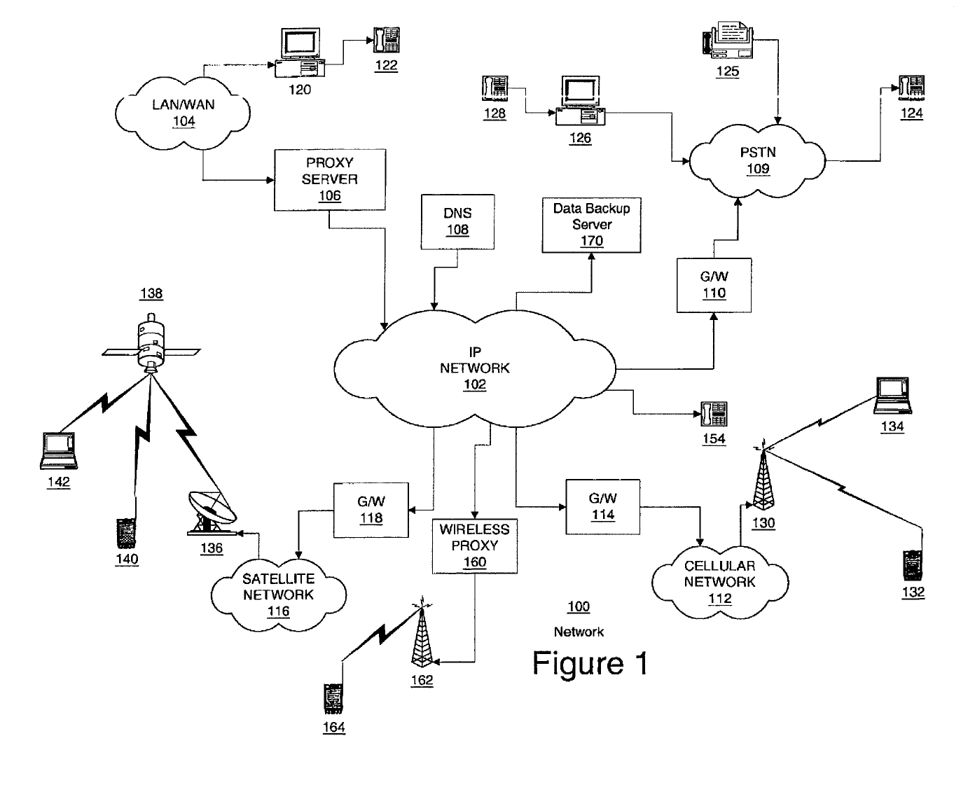

With reference now to the figures, and in particular with reference to FIG. 1, a system diagram illustrating a plurality of interconnected heterogeneous networks in which the present invention may be implemented is depicted. As illustrated, an Internet Protocol (IP) network 102, a Local Area Network (LAN)/Wide Area Network (WAN) 104, the Public Switched Telephone Network (PSTN) 109, a cellular wireless network 112, and a satellite communication network 116 make up the plurality of heterogeneous networks serviced by the personal mobility system of the present invention.

IP network 102 may be the publicly available IP network, a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper 152 is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4×10-character display with 16-gray levels and only a numeric keypad plus up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

Wireless Proxy 160 is coupled to IP network 102 and is coupled to a plurality of towers, e.g., 162, which each provide wireless communications with wireless devices such as wireless device 164. Wireless Proxy 160 provides access to IP network 102 to wireless device 164, such as a personal digital assistants (PDA) or a wireless telephone, that may require proprietary or other special protocols in order to communicate with IP network 102. For example, wireless proxy server 160 may be a 3Com server utilizing 3Com protocols for communicating with a Palm VII, a handheld portable computing device available from 3Com Corporation in Santa Clara, Calif.

In a preferred embodiment of the present invention, wireless proxy 160 is a 3Com proxy server supporting communications with Palm VII personal organizer and portable computing device 164 is a Palm VII personal organizer. In this embodiment, communications between wireless proxy server 160 and portable computing device 164 is facilitated by the use of Palm Query Applications (PQAs). A PQA is like a mini-Web site that resides on portable computing device 164. That is, a PQA is a special kind of record database. A typical PQA contains an HTML form or a list of hyperlinks that request additional information either locally—on personal computing device 164—or remotely—on the Internet.

Much of the content on the Internet is designed to take advantage of the power of Pentium/RISC-class computers with large, high resolution color monitors and fast and cheap Internet access. In these circumstances, there is little reason to economize on the abundant connect time and large file size that make Web browsing such a rich, multimedia experience from a desktop or notebook computer.

However, this model is not the best model for a small, low-power computer like the Palm VII organizer with its tiny screen, battery powered operation, and relatively slow and expensive wireless connection to the Internet. Rather than duplicate the Web browsing model on a handheld computer, PQAs are developed that access targeted bits of Internet information—like clippings from a newspaper. Typically, a handheld computer user does not focus on following hyperlinks to the Internet (although this is available), but instead, they compose a simple query in the PQA (for example a request for a stock quote) and then send that query over the air.

Also included in network 100 is Data Backup Server 170. Data Backup Server 170 is connected to IP network 102 and provides data backup for battery operated wireless devices, such as, for example, wireless telephones or PDAs, connected over IP network 102. However, it should be noted that the present invention may also be implemented within a non-IP based network. At predetermined intervals or when notified that a user has powered on a wireless device, the data backup server 170 pushes a command to the wireless device instructing the wireless device, such as wireless device 140, 164 or 132, to upload data, such as, for example, calendars, address lists, phone books, notepad data, appointments, or key configuration information, for backup on backup data server 170. The backup data server 170 stores the information along with an indication of ownership and then may provide the data to the owner when requested. The owner may request to download saved data, for example, after losing the information due to a battery failure. All of this is performed without notification of or action on the part of the user and may be performed during times when the wireless device is idle or using unused extra bandwidth during times when the wireless device is in use. Thus, the present invention provides cell phone and other wireless device users a painless and effortless mechanism for protecting valuable information and does not require user intervention.

FIG. 1 is intended as an example and not as an architectural limitation for the processes of the present invention.

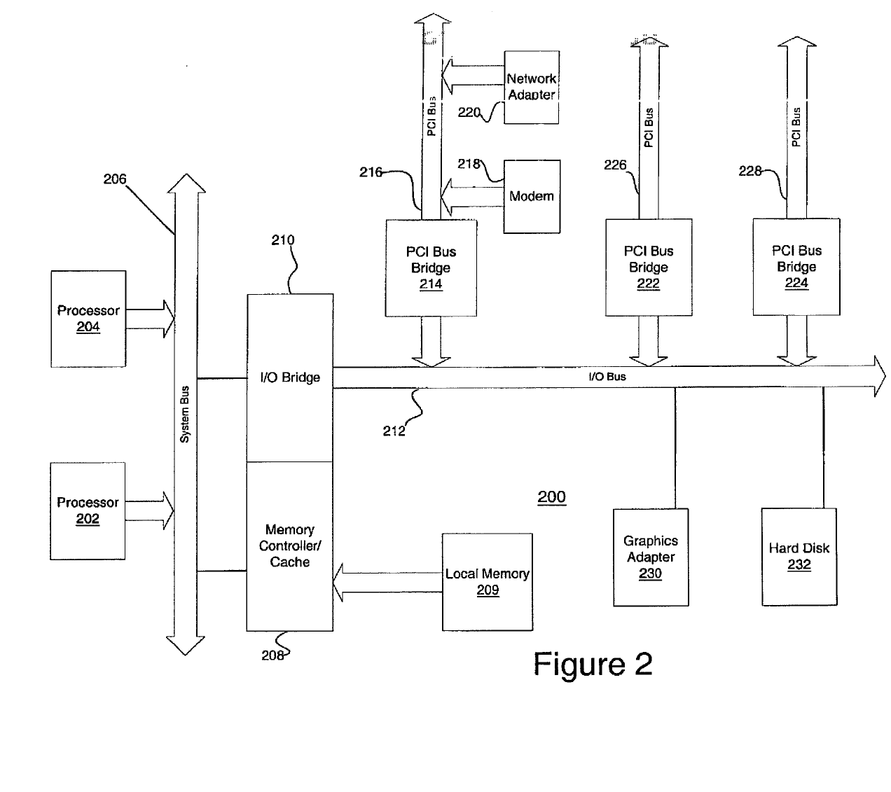

Referring to FIG. 2, a block diagram of a data processing system that may be implemented as a server, such as, for example, Data Backup Server 170 or any of the other servers in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

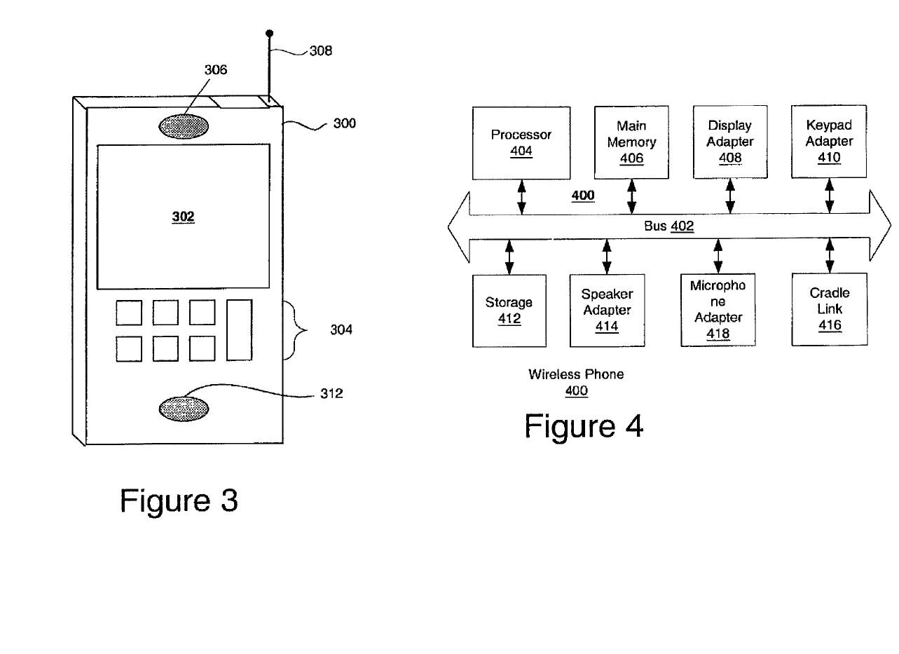

With reference now to FIG. 3, a diagram of a client in the form of a wireless telephone is depicted in accordance with a preferred embodiment of the present invention. Wireless telephone 300 includes a display 302 for presenting textual and graphical information. Display 302 may be a known display device, such as a liquid crystal display (LCD) device. The display may be used to present a map or directions, calendar information, a telephone directory, an electronic mail message, or the telephone number of a dialed party.

Wireless telephone 300 may also include keypad 304, speaker 306, antenna 308, and microphone 312. Keypad 304 may be used to receive user. Speaker 306 provides a mechanism for audio output, such as the voice audio of a party to whom the user of wireless telephone 300 may be speaking. Microphone 312 provides a mechanism for audio input such as for speaking to a called party. Antenna 308 provides a mechanism used in establishing a wireless communications link between wireless phone 300 and a network, such as network 102 in FIG. 1.

Turning now to FIG. 4, a block diagram of a wireless telephone is shown in accordance with a preferred embodiment of the present invention. Wireless telephone 400 is an example of a wireless telephone, such as wireless telephone 300 in FIG. 3, in which code or instructions implementing the processes of the present invention may be located. Wireless telephone 400 includes a bus 402 to which processor 404 and main memory 406 are connected. Display adapter 408, keypad adapter 410, storage 412, microphone adapter 418, and audio adapter 414 also are connected to bus 402. Cradle link 416 provides a mechanism to connect wireless telephone 400 to a cradle used in synchronizing data in wireless telephone 400 with another data processing system.

An operating system runs on processor 404 and is used to coordinate and provide control of various components within wireless telephone 400 in FIG. 4. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

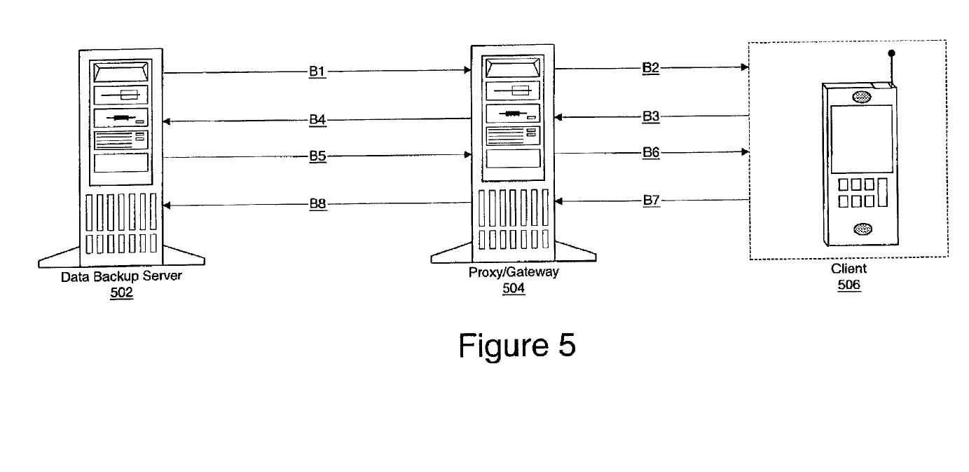

With reference now to FIG. 5, a diagram illustrating data flow between the data backup server and the wireless device is depicted in accordance with the present invention. In one embodiment, a data backup server 502 instructs B1 the proxy/gateway 504 to push a service loading content type (SL) B2 to the wireless client 506 requesting that the client 506 send its data to the data backup server 502 using, for example, the Push Access Protocol (PAP). More information about SL may be found in the “Wireless Application Protocol Service Loading Specification” which may be found on the Internet at http://wwwl.wapforum.org/tech/documents/WAP-168-ServiceLo ad-19991108-a.-pdf and is hereby incorporated by reference for all purposes. Typically, the SL command transferred in step B1 is textual and uses the HTTP protocol. The time at which the data backup server 502 initiates a backup operation may be set at predetermined intervals or maybe performed any time the data backup server 502 receives notification that client 506 has been powered on. Thus, in whatever implementation is chosen, the data from client 506 is backed up to data backup server 502 periodically or occasionally such that updates to data on client 506 may be backed up routinely. The data that is backed up may be, for example, a phone number list, an address list, a calendar, appointment schedules, notepad data, key configuration data, or any of a number of other types of data that may be stored on client 506.

Once proxy/gateway 504 receives the textual SL, the proxy/gateway 504 translates the textual SL into a binary SL suitable for the wireless client 506. Wireless client 506 may be, for example, a wireless telephone such as wireless phone 400 in FIG. 4 or maybe a personal digital assistant (PDA). The data backup server 502 provides the SL with the Uniform Resource Identifier (URI) to the Wireless Markup Language (WML) deck (i.e. application) that should be executed in client 506 in order to send the requested data to the data backup server 502. The proxy/gateway 504 sends the SL B2 to client 506 using, for example, the Push Over-the-Air (Push OTA) Protocol. The Push OTA Protocol is a standard protocol for conveying content between a push proxy/gateway and a client.

The client 506 receives the push B2 containing the SL, but, typically, the user of client 506 is not made aware of this. Client 506 waits for a period in which it is idle (i.e. the user is not using the client for other services) and then sends a request B3 to the proxy/gateway 504 to retrieve (pull) the application identified by the SL that will transfer the data from client 506 to the data backup server 502. The request B3 is typically made using a Wireless Session Protocol (WSP) Get command. The proxy/gateway 504 converts the WSP Get into an HTTP Get and sends B4 the request to the data backup server 502 or to some other server where the URI is located. The data backup server 502 then sends B5 the WML application in a textual format to proxy/gateway 504 where it is translated into a binary WML format and sent B6 to client 506.

Once client 506 receives the WML binary application, client 506 executes the WML binary application which transfers B7 the requested data from client 506 to proxy/gateway 504 using, for example, the Wireless Application Protocol (WAP). Proxy/gateway 504 translates the WAP data received from client 506 into an HTTP format and sends B8 the data to data backup server 502. Data backup server 502, upon receiving the data, stores the data, either on server 502 or in some remote storage location, with an indication of the client 506 to which the data belongs. Thus, if client 506 later loses the data, for example, because of battery failure, then client 506 may retrieve the data from data backup server 502 and reload the data.

A SL command is pushed to client 506 rather than the actual application that will transfer data from client 506 to data backup server 502 because is not always suitable to push content that is executed or rendered directly upon reception to a mobile device, such as client 506, especially if the client is busy with other activities such as executing another service. This is due to the fact that memory and/or processing constraints found in many mobile devices are such that neither storing nor processing content in such a situation is feasible. However, for devices where such constraints do not exist, it is possible, in other embodiments of the present invention, to push the application directly to the client, thus eliminating four data transfer steps.

In such an embodiment, the data backup server 502 would send the application to the proxy/gateway 504 for conversion into a protocol suitable for client 506. Proxy/gateway 504 then sends the application to client 506 which executes the application, thus retrieving and sending the requested data from client 506 to proxy/gateway 504. Proxy/gateway 504 receives the data from client 506 and translates the data into a protocol suitable for data backup server 502 and forwards the translated data to data backup server 502.

In yet another embodiment, it is possible, if the client 506 has sufficient memory, that the application necessary to retrieve and transmit the requested data is stored on client 506. In such case, data backup server 502 simply sends the request for data to client 506 via proxy/gateway 504. Client 506 then retrieves the requested data and sends the data back to data backup server 502 via proxy/gateway 504.

It is also possible in another embodiment, that the processes of the data backup server are incorporated into the proxy/gateway 504, thus eliminating a number of data transfer steps. However, such an embodiment would be uncommon given the current state of implementation of wireless networks.

Although depicted with reference to data backup server 502 initiating a backup process, in other embodiments, the client 506 may initiate the backup process.

FIG. 5 is intended as an example and not as an architectural limitation for the processes of the present invention.

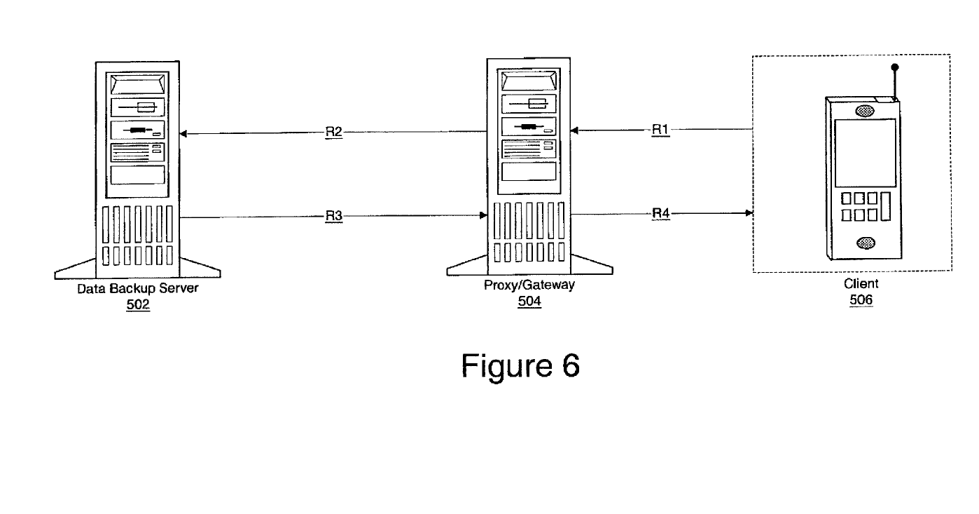

With reference now to FIG. 6, a pictorial diagram illustrating data flow for a client retrieving backed up data is depicted in accordance with the present invention. Whenever client 506 needs to retrieve backed up data, for example, because the battery has died in client 506 thus causing the loss of data, client 506 sends a request R1 to proxy/gateway 504 for the backed up data using, for example, a WAP protocol. Proxy/gateway 504 then translates the request into a format, such as HTTP, suitable for data backup server 502 and sends R2 the translated request to data backup server 502. Data backup server 502 retrieves the backed up data corresponding to the client 506 and sends R3 the requested data to proxy/gateway 504. Proxy/gateway 504 translates the data into a format suitable for client 506 and sends 504 the translated requested data to client 506 which can then store the data. Thus, even though client 506 may momentarily lose valuable data, it is not lost for good since the data is backed up on data backup server 502 and is retrievable.

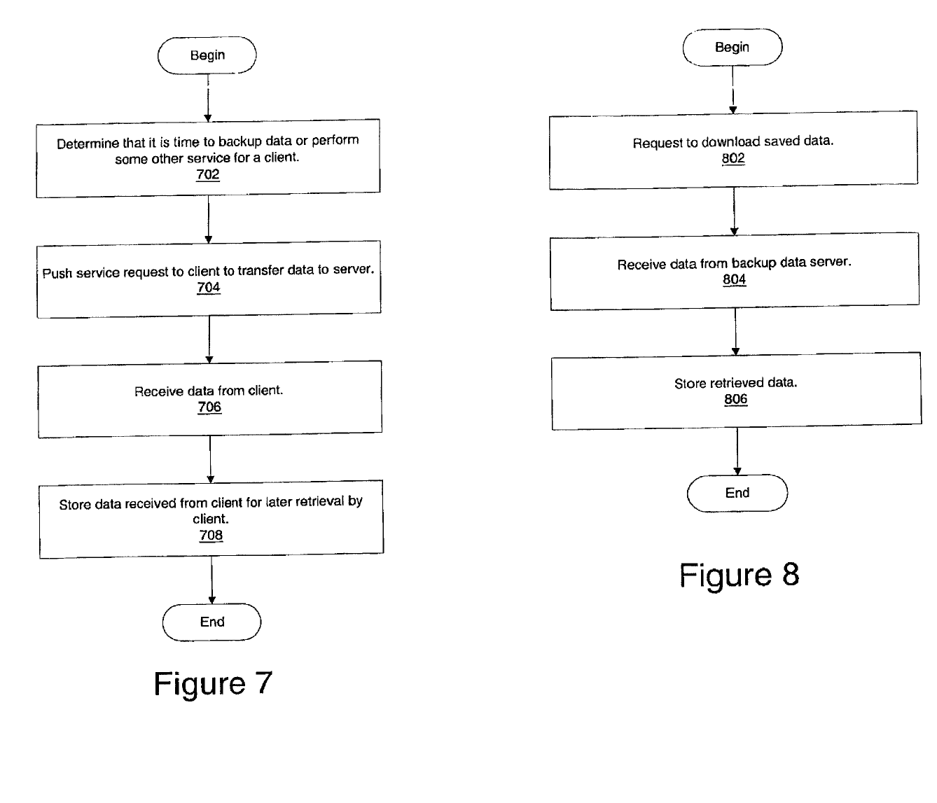

With reference now to FIG. 7, a process flow and program function for backing up data from a wireless device onto a server is depicted in accordance with the present invention. The process depicted may be implemented on, for example, data backup server 502 in FIG. 5. To begin, the data backup server determines that it is time to backup data from a client (step 702). This determination may be made based, for example, on the expiration on a predetermined amount of time from the last data backup or on the determination that the client has been powered on. Once the determination to perform a backup has been made, the data backup server pushes a data backup request to the client to transfer selected data to the data backup server (step 704). This request may involve sending a SL to the client and have the client retrieve an appropriate application to perform the backup or may merely be a request that the client can execute without retrieving any other application or data. The data backup server then receives the data from the client (step 706) and stores the data on the data backup server or on some remote storage device for later retrieval by the client if necessary (step 708).

With reference now to FIG. 8, a process flow and program function for reloading backed up data onto a client is depicted in accordance with the present invention. This reloading process may be implemented, for example, on client 506 in FIG. 6. The client sends a request to retrieve backed up data to the data backup server (step 802). The client then receives the data from the backup data server (step 804) and stores the retrieved data (step 806), thus refreshing or reloading data that may have been previously lost.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for backing up data, the method comprising:
establishing at a server a connection with a wireless device over a wireless network using a wireless protocol;
pushing a request to backup data to the wireless device;
receiving the data from the wireless device; and
storing the data on a storage device connected to the network.

2. The method as recited in claim 1, wherein the connection is established in response to receipt of an indication that the wireless device has been powered on.

3. The method as recited in claim 1, wherein connection is established periodically.

4. The method as recited in claim 1, wherein the connection is established in response to receipt of a request to backup data from the wireless device.

5. The method as recited in claim 1, wherein the step of pushing the request comprises sending a textual based service load to a proxy server, wherein the proxy server is configured to translate textual based service loads to binary based service loads and send the translated service load to the wireless device.

6. The method as recited in claim 5, wherein the service load provides a uniform resource identifier for an application that the wireless device may retrieve to transmit the data to the server.

7. The method as recited in claim 1, wherein the data includes at least one of phone lists, calendars, address lists and note.

8. The method as recited in claim 1, wherein the connection between the server and the wireless device uses unused extra bandwidth.

9. A method on a proxy server for facilitating data backup, the method comprising:
receiving a request in a first protocol from a backup server for a wireless client to backup data to the backup server;
translating the request formatted in the first protocol into a translated request formatted in a second protocol, wherein the second protocol is compatible with the wireless client;
sending the translated request to the wireless client over a wireless network;
receiving over the wireless network the data from the wireless client formatted in a third protocol;
translating the data formatted in the third protocol into translated data formatted in a fourth protocol compatible with the backup server; and
sending the translated data to the backup server.

10. The method as recited in claim 9, wherein the request is a textual based service load providing the client with a uniform resource identifier for an application which will identify, locate, and transmit the requested data to the backup server.

11. The method as recited in claim 9, wherein the translated request is a binary based service load.

12. The method as recited in claim 10, wherein the third protocol is a wireless application protocol.

13. The method as recited in claim 10, wherein the fourth protocol is a hypertext transfer protocol.

14. A method for backing up data, the method comprising:
responsive to receipt of a push from a backup server via a wireless network to backup data, retrieving, without user intervention, the data to be backed up from storage within the a wireless client; and
transmitting, without user intervention, the data to be backed up to the backup server via the wireless network utilizing a wireless protocol.

15. The method as recited in claim 14, wherein the data to be backed up is sent to the server by way of a proxy server and is sent using a wireless application protocol.

16. The method as recited in claim 14, further comprising:
transmitting a request to the backup server via the wireless network to retrieve backed up data;
receiving the backed up data from the backup server via the wireless network; and
storing the backed up data on the wireless client.

17. A method on a server for reloading backed up data, the method comprising:
receiving a request for backed up data from a wireless client connected via a wireless network;
retrieving the backed up data corresponding to the wireless client; and
transmitting the backed up data to the wireless client via the wireless network.

18. A computer program product in a computer readable media for use in a data processing system implemented as a server for backing up data, the computer program product comprising:
first instructions for establishing a connection with a wireless device over a wireless network using a wireless protocol;
second instructions for enabling a request to backup data to be pushed to the wireless device;
third instructions for receiving the data from the wireless device; and
fourth instructions for storing the data on a storage device connected to the wireless network.

19. The computer program product as recited in claim 18, wherein the connection is established in response to receipt of an indication that the wireless device has been powered on.

20. The computer program product as recited in claim 18, wherein the first instructions comprise instructions for establishing the connection periodically.

21. The computer program product as recited in claim 18, wherein the connection is established in response to a request to backup data received from the wireless device.

22. The computer program product as recited in claim 18, wherein the second instructions comprise instructions enabling the transmission of a textual based service load to a proxy server, wherein the proxy server is configured to translate textual based service loads to binary based service loads and send the translated service load to the wireless device.

23. The computer program product as recited in claim 22, wherein the service load provides a uniform resource identifier for an application that the wireless device may retrieve to transmit the data to the server.

24. A computer program product in a computer readable media for use in a data processing system implemented as a proxy server for facilitating data backup, the computer program product comprising:
first instructions for enabling receipt of a request, formatted in a first protocol, from the backup server for a wireless client to backup data to the backup server via a wireless network;
second instructions for translating the request formatted in the first protocol into a translated request formatted in a second protocol, wherein the second protocol is compatible with the wireless client;
third instructions for enabling the transmission of the translated request to the wireless client;
fourth instructions for enabling the receipt of the data from the wireless client formatted in a third protocol;
fifth instructions for translating the data formatted in the third protocol into translated data formatted in a fourth protocol compatible with the backup server; and
sixth instructions for enabling the transmission of the translated data to the backup server.

25. A computer program product in a computer readable media for use in a data processing system implemented as a wireless client for backing up data, the computer program product comprising:
first instructions, responsive to receipt of a push from a backup server via a wireless network to backup data, for retrieving, without user intervention, the data to be backed up from storage within a wireless client; and
second instructions for enabling the transmission of the data, without user intervention, to be backed up to the server via the wireless network utilizing a wireless protocol.

26. A computer program product in a computer readable media for use in a data processing system implemented as a server for reloading backed up data, the computer program product comprising:
first instructions for enabling the receipt of a request for backed up data from a wireless client connected via a wireless network;
second instructions for retrieving the backed up data corresponding to the wireless client; and
third instructions for enabling the transmission of the backed up data to the wireless client via the wireless network.

27. A system for backing up data from a wireless device onto a server via a network, the system comprising:
a communication unit which establishes a connection with a wireless device over a wireless network;
a backup initiator which pushes a request to backup data to the wireless device;
a receiver which receives the data from the wireless device; and
storing unit which stores the data on a storage device connected to the network.

28. The system as recited in claim 27, wherein the connection is established in response to receipt of an indication that the wireless device has been powered on.

29. The system as recited in claim 27, wherein the connection is established periodically.

30. The system as recited in claim 27, wherein the connection is established in response to a request to backup data received from the wireless device.

31. A system for facilitating data backup, the system comprising:
a request receiver which receives a request in a first protocol from a backup server requesting that a wireless client backup data to the backup server;
a first translator which translates the request formatted in the first protocol into a translated request formatted in a second protocol, wherein the second protocol is compatible with the wireless client;
a first transmitter which sends the translated request to the wireless client via a wireless network;
a data receiver which receives the data from the wireless client via the wireless network formatted in a third protocol;
a second translator which translates the data formatted in the third protocol into translated data formatted in a fourth protocol compatible with the backup server; and
a second transmitter which sends the translated data to the backup server.

32. The system as recited in claim 31, wherein the request is a textual based service load providing the client with a uniform resource identifier for an application which will identify, locate, and transmit the requested data to the backup server.

33. The system as recited in claim 31, wherein the translated request is a binary based service load.

34. The system as recited in claim 31, wherein the third protocol is a wireless application protocol.

35. The system as recited in claim 31, wherein the fourth protocol is a hypertext transfer protocol.

36. A system for backing up data to a server via a network, the system comprising:
a data retriever which, responsive to receipt of a push from a backup server via a wireless network to backup data, retrieves, without user intervention, the data to be backed up from storage within the client; and
a transmitter which transmits, without user intervention, the data to be backed up to the backup server via the wireless network utilizing a wireless protocol.

37. The system as recited in claim 36, wherein the wireless device is a wireless phone.

38. The system as recited in claim 36, wherein the wireless device is a personal digital assistant.

39. A system for reloading backed up data onto a wireless client, the system comprising:
a receiver which receives a request for backed up data from the wireless client;
a retrieval unit which retrieves the backed up data corresponding to the wireless client; and
a transmitter which transmits the backed up data to the wireless client.
